(19) United States
(12) Patent Application Publication
(10) Pub. No.: US 2022/0197058 A1
(43) Pub. Date: Jun. 23, 2022

(54) EYEGLASS LENS FOR SUPPRESSING PROGRESSION OF MYOPIA

(71) Applicant: TOKAI OPTICAL Co., LTD., Okazaki-shi (JP)

(72) Inventor: Eiji SUZUKI, Okazaki-shi (JP)

(21) Appl. No.: 17/559,521

(22) Filed: Dec. 22, 2021

(30) Foreign Application Priority Data
Dec. 23, 2020 (JP) 2020-213185

(51) Int. Cl. G02C 7/06

(52) U.S. Cl. CPC G02C 7/06; G02C 2202/24

(57) ABSTRACT

Eyeglass lenses useful for suppressing the progression of myopia are described. The eyeglass lenses may realize improved vision through myopia refractive correction viewability and suppression of the progression of myopia at the same time. In some examples, the eyeglass lens includes a first region for viewing a comparatively far distance disposed at an upper side of a lens, a second region disposed lower than the first region and having more positive refractive power than the first region, and a progressive zone region in which refractive power progressively changes provided between the first region and the second region. The eyeglass lens may have a progressive power surface with an addition gradient set so that addition power is gradually added from the first region to the second region on a back surface of the lens.

### CROSS-REFERENCE TO RELATED APPLICATION(S)

This application claims priority to Japanese Application No. 2020-213185 filed on Dec. 23, 2020, which is incorporated by reference herein in its entirety.

### TECHNICAL FIELD

The present disclosure relates generally to eyeglass lenses, including systems and methods for suppressing the progression of myopia using such eyeglass lenses.

### BACKGROUND

One of the factors that causes the progression of myopia is hyperopic blur (forming a clear image behind the retina) at the central part of the retina caused by an accommodation lag when viewing a near distance (insufficient or omission of lens accommodation with respect to lens accommodation power required for focusing on a near object). That is, a process is undergone in which a focal point of the central part of the retina is behind the retina, and an eye axis accordingly extends, and the eye becomes long in the front-rear direction, and as a result, myopia progresses. Therefore, provision of power for assisting accommodation power by eyeglasses when viewing a near distance to prevent a clear image from being formed behind the retina leads to suppression of the progression of myopia.

There is the idea that, to suppress the progression of myopia, not only an image forming state at the center of the retina but also an image forming state in the retina periphery are important. This theory is because the eye axis also extends at the retina periphery due to hyperopic blur and the retina periphery also causes the progression of myopia, and therefore, the progression of myopia can be suppressed by preventing a focal point on the retina periphery from being formed behind the retina by correction with eyeglasses.

Eyeglasses intended to prevent image formation behind the retina in the retina periphery in prior disclosures have certain disadvantages. For example, U.S. Pat. No. 10,268,050 discloses an eyeglass lens forming a second refraction area of a plurality of convex lens-like island-shaped areas 2 independent from each other formed in a ring shape around a first ametropia correcting area 1. With this eyeglass lens, a focal point on the retina periphery is corrected to be formed in front of the retina due to the plurality of island areas 2. However, when a visual line is directed downward to view a near distance, the second refraction area (that is, island-shaped areas 2) is in a ring shape, so that the visual line may overlap the second refraction area, and downward vision may not be good. When viewing a near distance, an accommodation lag occurs theoretically, so that the myopia progression suppressing effect for a user who often views a near distance may deteriorate.

### SUMMARY

The present disclosure includes eyeglass lenses and related systems and methods that may address one or more disadvantages or shortcomings of prior systems. For example, the present disclosure includes an eyeglass lens for suppressing the progression of myopia, the eyeglass lens comprising a first region for viewing a comparatively far distance, e.g., disposed at an upper side of a lens; and a second region disposed at a lower side than the first region and having more positive refractive power relatively than the first region, wherein a myopia progression suppressing region is disposed to surround a periphery of the first region and the second region. The myopia progression suppressing region may comprise or consist of a group of convex lenses (e.g., a group of a large number of convex lenses) having a larger curvature than a front surface of the lens and spaced from each other so as to spread in two-dimensional directions. Further, for example, the group of the convex lenses disposed close to a center side of the lens may have a smaller curvature than the group of the convex lenses disposed close to an outer circumference of the lens. The group of the convex lenses may comprise or consist of convex lenses having toroidal surface shapes, e.g., disposed at an angle that cancels out astigmatism of the lens.

The myopia progression suppressing region may be a rough surface region in which the lens front surface scatters light, optionally configured to surround the periphery of the first region and the second region. In some examples, the myopia progression suppressing region may be configured so as to include a rough surface region that is formed into two or more independent island shapes. Additionally or alternatively, the myopia progression suppressing region may be a region that surrounds the first region and the second region from the circumference, e.g., so as to assume a ring-shaped donut form. The myopia progression suppressing region may be disposed at left and right positions across the first region and the second region, for example.

In some examples, a distribution density of the group of convex lenses (e.g., the large number of the convex lenses) distributed in the myopia progression suppressing region may be set to become lower at the lower side than at the upper side. Further, for example, a distribution density of the large number of spots distributed in the rough surface regions may be set to become lower at the lower side than at the upper side. In some examples, a distribution density of the group of a large number of the convex lenses disposed close to the center side of the lens is set to be lower than a distribution density at a position close to the outer circumference of the lens. In some examples, a distribution density of the rough surface regions disposed close to the center side of the lens is set to be lower than a distribution density at a position close to the outer circumference of the lens. The convex lenses disposed in the left-right direction of the second region may produce smaller positive power than the convex lenses not disposed in the left-right direction of the second region.

Further, for example, a progressive zone region in which refractive power progressively changes may be provided between the first region and the second region, and an addition gradient may be set so that addition power is gradually added from the first region to the second region. In some examples, the myopia progression suppressing region is disposed at left and right positions across the progressive zone region and the second region. Further, for example, the myopia progression suppressing region may be formed on a surface on a side different from either the front surface or the back surface of the lens on which the first region, the second region, and the progressive zone region are provided.

With respect to a surface ratio obtained by dividing a total area occupied by the myopia progression suppressing region by a total area occupied by a portion other than the myopia progression suppressing region, the area ratio in the vicinity of the first region may be smaller than the area ratio in the vicinity of the second region. In some examples, the myopia progression suppressing region comprises or consists of the group of the convex lenses, and/or refractive power of the convex lens disposed in the vicinity of the progressive zone region and the second region may be set to be more positive than refractive power of the convex lens in the myopia progression suppressing region disposed in the vicinity of the first region.

### BRIEF DESCRIPTION OF THE DRAWINGS

The accompanying drawings, which are incorporated in and constitute a part of this application, illustrate various exemplary embodiments and together with the description, serve to explain the principles of the disclosed embodiments.

FIGS. 1A and 1B are diagrams illustrating lens properties of a myopia suppressing lens of a first embodiment, FIG. 1A is an average power distribution chart in a light transmitting condition, and FIG. 1B is an astigmatism distribution chart in the same condition.

FIG. 2 is an explanatory view describing a distribution state of spots in a myopia progression suppressing region formed on a front surface of the myopia suppressing lens of the first embodiment.

FIG. 3 is a sectional view taken along line A-A in FIG. 2.

FIG. 4 is an explanatory view describing a distribution state of spots in a myopia progression suppressing region formed on a front surface of a myopia suppressing lens according to a second embodiment.

FIG. 5 is a sectional view taken along line B-B in FIG. 4.

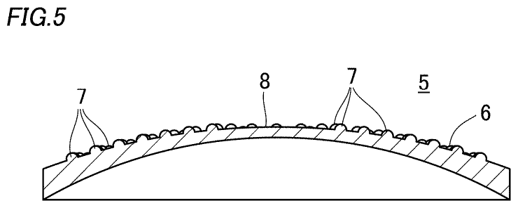

FIG. 6 is an explanatory view describing a distribution state of spots in a myopia progression suppressing region formed on a front surface of a myopia suppressing lens according to a third embodiment.

FIG. 7 is an explanatory view describing a distribution state of spots in a myopia progression suppressing region formed on a front surface of a myopia suppressing lens according to a fourth embodiment.

FIGS. 8A-8C are explanatory views describing a power change when canceling astigmatism of a base lens by a spot having a toroidal surface in the fourth embodiment.

FIG. 9 is an explanatory view for describing forms of lines passing through a center of the toroidal surface of the spot having the toroidal surface in the fourth embodiment.

FIG. 10 is an explanatory view describing a distribution state of spots in a myopia progression suppressing region formed on a front surface of a myopia suppressing lens of a fifth embodiment.

FIG. 11 is an explanatory view describing a distribution state of spots in a myopia progression suppressing region formed on a front surface of a myopia suppressing lens of a seventh embodiment.

FIG. 12 is an explanatory view describing a distribution state of spots in a myopia progression suppressing region formed on a front surface of a myopia suppressing lens of another embodiment.

FIG. 13 is an explanatory view for describing island-shaped rough surface regions in a tenth embodiment.

FIG. 14 is a plan view of a myopia suppressing lens having rough surface regions of another embodiment.

FIGS. 15A-15C are explanatory views of images of rough surfaces for describing patterns of rough surface forming positions

### DETAILED DESCRIPTION

According to the present disclosure, the problems described above may be improved and an eyeglass lens for suppressing the progression of myopia is provided which provides for better vision, e.g., through myopia refractive correction vision and suppression of the progression of myopia at the same time.

In order to solve the problems above, the gist of a first means resides in that an eyeglass lens includes a first region for viewing a comparatively far distance, disposed at an upper side of a lens, and a second region disposed at a lower side than the first region and having more positive refractive power relatively than the first region, wherein a myopia progression suppressing region is disposed to surround a periphery of the first region and the second region.

With this eyeglass lens for suppressing the progression of myopia, a focal point on the retina periphery is disposed in front of the retina due to the myopia progression suppressing region surrounding the periphery of the first region and the second region, so that an effect of suppressing the progression of myopia is obtained. In addition, when viewing a near distance, the second region having more positive refractive power than the first region can be used, so that an accommodation lag is less likely to occur, and the effect of suppressing the progression of myopia is less likely to deteriorate.

The “first region for viewing a comparatively far distance, disposed at an upper side of a lens” and the “second region having more positive refractive power than the first region” may be a lens having a lens power progressively added so as not to have a discontinuous portion between the first region and the second region such as, for example, a progressive power lens, or may be a lens having a discontinuous portion between the first region and the second region such as, for example, a BF (bifocal) lens accompanied by a small lens or a Franklin lens divided into two upper and lower portions.

Although a clear boundary may be provided between the first region, the second region and the myopia progression suppressing region, particularly in a lens having a progressively added lens power and having no discontinuous portion like a progressive power lens, depending on the shape of the myopia progression suppressing region, the region may have a portion overlapping a part (outer side) of the first region and the second region.

The myopia progression suppressing region is a region that prevents an image of incident light directed toward the retina periphery from being formed behind the retina by an optical effect, and is a region in which a landscape through the eyeglass lens cannot be clearly viewed. The myopia progression suppressing region is a region that transmits light but cannot form a focal point in the vicinity of the retina when a lens wearer views, such as, for example, a convex lens or rough surface, etc., described herein.

The gist of a second means resides in that the myopia progression suppressing region consists of a group of a large number of convex lenses having a larger curvature than a front surface of the lens and spaced from each other so as to spread in two-dimensional directions.

In a case where the convex lens is a convex lens with a larger curvature than the lens front surface, when incident light is focused on the retina periphery, an image of the light is not formed behind the retina, so that an effect of suppressing the progression of myopia is obtained. In addition, when viewing a near distance, the second region having more positive refractive power than the first region can be used, so that an accommodation lag is less likely to occur, and the effect of suppressing the progression of myopia is less likely to deteriorate. In addition, in an eyeglass lens portion without a convex lens, the visual line is transmitted through, so that a clear vision region is accordingly widened.

The size of each convex lens preferably has a diameter of approximately 0.1 to 3 mm. All convex lenses may have or may not have the same size. A pupil diameter of a lens wearer is approximately 3 mm, and if the convex lenses become sufficiently larger than this pupil diameter, when the visual line passes through the convex lens portion, viewability depends on only the convex lenses, and the visual field is obstructed. The large number means not only a plurality but also a number necessary for obtaining the optical effect.

The group of convex lenses can suppress obstruction of the visual field in the myopia progression suppressing region to some degree by creating a state where light rays that do not pass through the convex lenses and light rays that pass through the convex lenses are mixed in a constant ratio in light rays passing through the pupil.

It is preferable that an interval between the convex lenses adjacent to each other is equal to the diameter of the convex lenses. Of course, the adjacent interval does not necessarily have to be equal to the diameter. The convex lenses do not necessarily have to all have the same shape, and may be arranged at even intervals or may be arranged randomly.

The convex lenses are preferably arranged so that a density of a portion overlapping the visual field (portion close to the lens center in the vertical direction), in particular, a near vision portion is lower (sparse) than a density of a portion far from the visual field.

For example, in a region having great aberration of a base lens and not assumed to be used for viewing an object through the region like a lateral side of a near vision portion of a progressive power lens, the convex lenses may be arranged at narrower intervals or at no intervals.

On the other hand, in a region having less aberration of the base lens and assumed to be used for viewing an object through the region like a lateral side of a far vision portion, the convex lenses are preferably arranged at sufficient intervals.

In the case of a progressive power lens, when eyeglasses slide down, the downward visual line does not pass through the near vision portion to which positive power is added, and the effect of suppressing an accommodation lag when viewing a near distance disappears. A lens wearer does not notice this since positive power is progressively added.

In order to prevent the problem above, at an upper side of the far vision portion, convex lenses are arranged at a high density by reducing or eliminating adjacent intervals, and accordingly, an effect of causing the wearer to notice the sliding down of the eyeglasses can also be obtained.

The myopia progression suppressing region consisting of a large number of convex lenses may be disposed as a ring-shaped region around the first region and the second region, or may be disposed at the left and the right so that major portions of the first region and second region at upper and lower sides from the center remain. When the myopia progression suppressing region is disposed at the left and the right, the myopia progression suppressing regions are preferably disposed in a region lower than the center. This disposition is preferable since the visual field in the region lower than the center is narrower than in the upper region although it is desirable to secure the visual field in a region higher than the center.

An eyeglass lens having these convex lenses is preferably manufactured by, for example, using a lens mold and curing a thermosetting monomer.

The gist of a third means resides in that the group of the convex lenses disposed close to a center side of the lens has a smaller curvature than the group of the convex lenses disposed close to an outer circumference of the lens.

A portion close to the center side of the lens is likely to enter the visual field of a user, so that by setting a curvature to be relatively smaller than that of a portion close to the outer circumference of the lens, a sense of discomfort in use can be reduced.

The gist of a fourth means resides in that the group of a large number of the convex lenses consists of convex lenses having toroidal surface shapes, and are disposed at an angle that cancels out astigmatism of the lens.

The toroidal surface is a surface with different curvatures in perpendicular directions on a toric surface like a surface of a donut. Astigmatism is aberration caused by a difference between refractive powers in perpendicular directions on a lens surface, so that when a convex lens is a convex lens having a toroidal surface shape, by disposing a convex lens at an angle that cancels out astigmatism of the lens surface, the astigmatism is reduced.

The gist of a fifth means resides in that the myopia progression suppressing region is a rough surface region in which the lens front surface scatters light, and is configured to surround the periphery of the first region and the second region.

Accordingly, an image of incident light directed toward the retina periphery is not formed behind the retina, so that the effect of suppressing the progression of myopia is obtained.

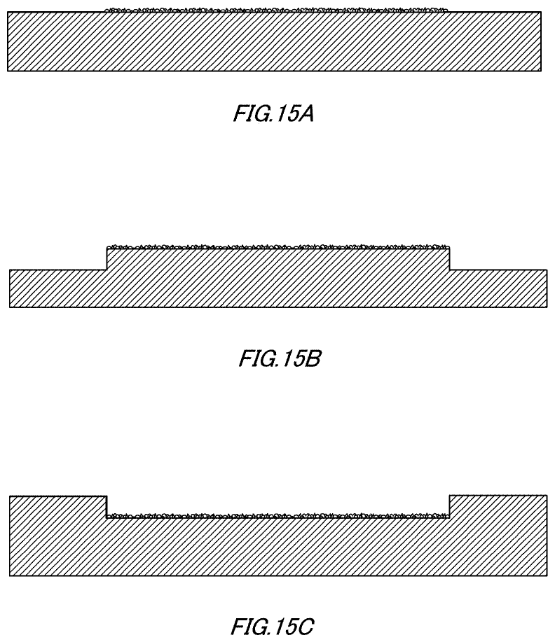

The rough surface region is a region in which light can be viewed although light is scattered and cannot be clearly viewed. The rough surface region may be formed of a surface enabling the entirety of the inside of the rough surface region to scatter light, and a large number of regions that scatter light may be arranged as a large number of spots spaced from each other so as to spread in two-dimensional directions in a planar view. For scattering light, for example, the rough surface region is preferably formed to have a large number of fine protrusions having a large number of surfaces different in angle as illustrated in FIGS. 15A to 15C. According to this configuration, a frosted glass that scatters light is formed.

As the rough surface region, for example, a rough surface may be formed by directly applying sand blasting to the eyeglass lens, or an eyeglass lens having a rough surface region may be manufactured by using a lens mold after forming a rough surface on the lens mold by sand blasting.

The gist of a sixth means resides in that the myopia progression suppressing region is configured so as to include a rough surface region that is formed into two or more independent island shapes.

Accordingly, when incident light is focused on the retina periphery, an image of the incident light is not formed behind the retina, so that an effect of suppressing the progression of myopia is obtained, and in addition, in an eyeglass lens portion having no island-shaped rough surface region, the visual line is transmitted and a clear vision region is accordingly widened.

Based on a front surface of the lens as a reference surface, the island-shaped rough surface region may be formed at the same height position as the reference surface as illustrated in FIG. 15A, may be formed at a position projecting upward as illustrated in FIG. 15B, or conversely, may be formed at a recessed position so as to form a recess as illustrated in FIG. 15C.

A rough surface region may be composed of a number of independent island-shaped spots.

The gist of a seventh means resides in that the myopia progression suppressing region is a region that surrounds the first region and the second region from the circumference so as to assume a ring-shaped donut form.

This is a claim of a detailed example of a position where the myopia progression suppressing region is formed. As in this case, when the myopia progression suppressing region is a surrounding region assuming a ring-shaped donut form, it covers the entire region of the retina periphery, so that the effect of suppressing the progression of myopia increases.

The gist of an eighth means resides in that the myopia progression suppressing region is disposed at left and right positions across the first region and the second region.

This is a claim of a detailed example of a position where the myopia progression suppressing region is formed. As in this case, when the myopia progression suppressing region is provided at both sides of the first region and the second region, the visual field is secured from a distance field to a near field, and normal use as eyeglasses becomes less stressful.

The gist of a ninth means resides in that a distribution density of the group of the convex lenses or the rough surface regions distributed in the myopia progression suppressing region is set to become lower at the lower side than at the upper side.

Accordingly, difficulty in viewing due to the presence of convex lenses in the visual line direction of a wearer when the wearer views downward is reduced. The distribution density may discontinuously or continuously and gradually change.

The gist of a tenth means resides in that a distribution density of the group of the convex lenses or the rough surface region composed of a number of independent island-shaped spots disposed close to the center side of the lens is set to be lower than a distribution density at a position close to the outer circumference of the lens.

With this means, normal use as eyeglasses becomes less stressful.

The gist of an eleventh means resides in that the convex lenses disposed in the left-right direction of the second region produce smaller positive power than the convex lenses not disposed in the left-right direction of the second region.

Accordingly, when the wearer views downward, it can be prevented that power of the convex lenses overlap the power of the second region and causes excessive positive power.

The gist of a twelfth means resides in that a progressive zone region in which refractive power progressively changes is provided between the first region and the second region, and an addition gradient is set so that addition power is gradually added from the first region to the second region.

That is, the lens has a progressive power surface as a progressive power lens. When the eyeglass lens for suppressing the progression of myopia uses the first region and the second region as the progressive power lens described above, the visual line can be smoothly moved without image discontinuity (prism jump) on the boundary between the far vision portion and the near vision portion, and when viewing a near distance, the second region can be used and an accommodation lag is less likely to occur.

The gist of a thirteenth means resides in that the myopia progression suppressing region is disposed at left and right positions across the progressive zone region and the second region.

That is, the myopia progression suppressing region is not disposed in the first region having a wide visual field, and since the visual field becomes comparatively narrow when viewing a near distance, by disposing the myopia progression suppressing region on both sides of the progressive zone region and the second region of the lower region, the progression of myopia can be suppressed while the visual field is secured.

For example, the myopia progression suppressing region is preferably a region surrounding the first region from a position 3 mm or more higher than a center of the first region.

The gist of a fourteenth means resides in that the myopia progression suppressing region is formed on a surface on a side different from either the front surface or the back surface of the lens on which the first region, the second region, and the progressive zone region are provided.

Accordingly, the lens surface on the side where the convex lenses are formed can be formed into a base surface with a simple shape, so that the convex lenses can be easily designed, and a myopia progression suppressing region with a uniform shape is easily formed. The myopia progression suppressing region side is preferably formed as a surface on the object side.

The gist of a fifteenth means resides in that, with respect to a surface ratio obtained by dividing a total area occupied by the myopia progression suppressing region by a total area occupied by a portion other than the myopia progression suppressing region, the area ratio in the vicinity of the first region is smaller than the area ratio in the vicinity of the second region.

Accordingly, in a progressive power lens, the vicinity of the second region, in particular, left and right regions have a concentration of astigmatism and distortion, and frequency of viewing an object through these portions is low. However, these regions are regions that easily cause hyperopic blur in the retina periphery when viewing a near distance. Therefore, with this means, for example, bulges as the convex lens are disposed at a relatively higher density in these portions to efficiently exert the myopia progression suppressing effect without comparatively losing the visual field.

The gist of a sixteenth means resides in that the myopia progression suppressing region consists of the group of the convex lenses, and refractive power of the convex lens disposed in the vicinity of the progressive zone region and the second region is set to be more positive than refractive power of the convex lens in the myopia progression suppressing region disposed in the vicinity of the first region.

It is assumed that as the refractive power of the convex lens body becomes more positive, the myopia progression suppressing effect increases, however, on the other hand, a refractive power difference from the portion other than the convex lenses increases, so that viewability through the myopia progression suppressing region deteriorates.

In addition, the regions across the second region have a concentration of astigmatism and distortion of the progressive power lens, so that the frequency of viewing an object through these portions is low. However, when viewing a near distance, these regions are regions that easily cause hyperopic blur in the retina periphery. Therefore, in the present means, by disposing convex lenses with more positive power in these regions, the myopia progression suppressing effect can be efficiently exerted without comparatively losing the visual field.

The examples shown in the respective means described above can be arbitrarily combined. For example, at least part of the configuration of at least one of the disclosed second and subsequent means may be added to the whole or part of the configuration of the invention shown in the first means. In particular, at least part of the configuration of at least one of the disclosed second and subsequent means is preferably added to the invention shown in the first means. It is also possible that arbitrary configurations are extracted from the examples shown in first to sixteenth means, and the extracted configurations are combined. The applicant of the present application has the intention to acquire the rights to the examples including these configurations.

By wearing an eyeglass lens for suppressing the progression of myopia according to the invention as claimed in this application, due to the myopia progression suppressing region surrounding the first region and the second region, a focal point on the retina periphery is disposed in front of the retina, so that an effect of suppressing the progression of myopia of a wearer is obtained. When viewing a near distance through this lens, the second region having more positive refractive power relatively than the first region can be used, so that an accommodation lag is less likely to occur, and the effect of suppressing the progression of myopia is less likely to deteriorate.

Reference will now be made in detail to the exemplary embodiments of the present disclosure, examples of which are illustrated in the accompanying drawings. Wherever possible, the same reference numbers will be used throughout the drawings to refer to the same or like parts.

Hereinafter, detailed embodiments of an eyeglass lens for suppressing the progression of myopia (hereinafter, referred to as myopia suppressing lens) will be described.

### First Embodiment

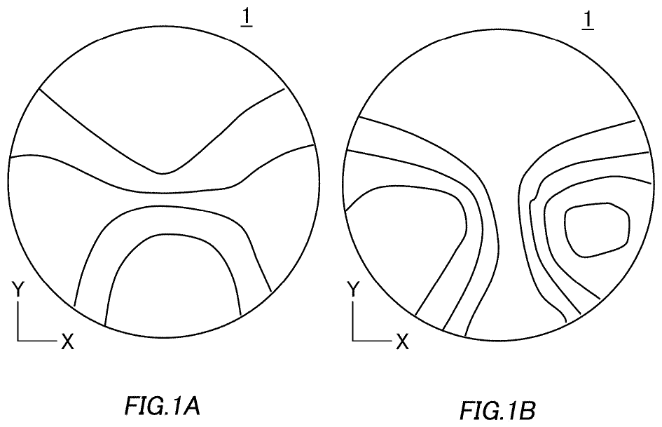

As a first embodiment, a myopia suppressing lens 1 having progressive properties illustrated in FIGS. 1A and 1B on a lens back surface was manufactured. In FIGS. 1A and 1B, the X direction represents the horizontal direction during use of the eyeglass lens, and the Y direction represents the vertical direction in the same state. Basic design conditions for the myopia suppressing lens 1 are as follows.

For both of the left and right lenses, S-1.00D, ADD 1.50D, inset theoretical value of 2.1 mm, and a progressive zone length of 13 mm were set. That is, as illustrated in FIG. 1A, the average power (lens power) is 5-1.00D in a far vision region, and the average power is 0.50D in a near vision region.

As seen from FIG. 1B, the far vision region higher than the center is a wide region and has no astigmatism, and this region narrows toward a lower side and becomes a narrow progressive zone region, and expands again in the near vision region. The region without astigmatism of the near vision region is narrower than the far vision region, but is wide enough when viewing a near distance. Astigmatism concentrates on left and right sides of the progressive zone region.

The myopia suppressing lens 1 is an aspheric lens made of a material with a refractive index of 1.60, and has:

Front surface: 2.0 curve (based on 1.523)

Back surface: Progressive form determined to have predetermined myopia correction and accommodation assisting power

Central thickness: 1.0 mm

Lens diameter: 75 mm

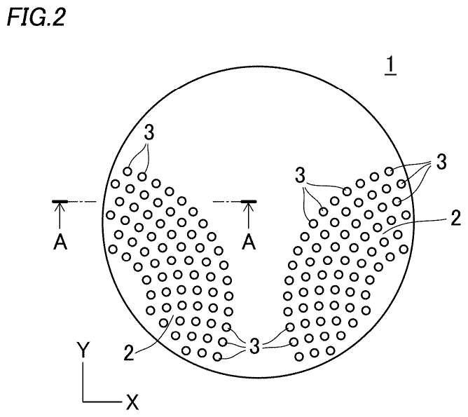

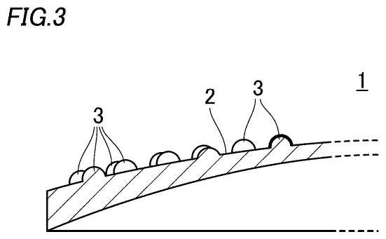

As illustrated in FIGS. 2 and 3, on a lens front surface of the myopia suppressing lens 1, myopia progression suppressing regions 2 are formed. The X direction in FIG. 2 is a horizontal direction during use of the eyeglass lens, and the Y direction is a vertical direction in the same state. The myopia progression suppressing region 2 consists of a group of a large number of dome-shaped small spots 3. In the myopia progression suppressing region 2, an area ratio of an area occupied by all spots 3 and an area occupied by a portion other than the spots 3 is set to 1 to 1 in the first embodiment.

The myopia progression suppressing regions 2 are disposed at both left and right positions avoiding a progressive zone at the center in a lens vertical direction in a lens lower region so as not to overlap a far vision region. These disposed positions are regions that approximately overlap with regions having a concentration of astigmatism in the astigmatism distribution chart in FIG. 1B. That is, the myopia progression suppressing regions 2 are disposed in regions that do not obstruct the visual field in the far vision region, the progressive zone region, and a near vision region, and are regions in which incident light is focused on the retina periphery.

As illustrated in FIG. 3, the spots 3 in the first embodiment are dome-shaped convex lenses with a diameter of 2 mm molded integrally with the myopia suppressing lens 1. The spot 3 has a perfect circular external shape as viewed from a vertex direction of the spot 3. In the present first embodiment, the myopia progression suppressing regions 2 consist of groups of six curved rows separated into left and right and substantially along astigmatism directions convex inward respectively formed of pluralities of spots 3 arranged in series. In the row direction, the spots 3 are arranged at intervals of 2 mm, and the rows are successively arranged in an orderly manner so that a distance between row centerlines is 4 mm. The curve of the spots 3 is 5.0 curve based on 1.523.

With the myopia suppressing lens 1 illustrated in the first embodiment, an effect of suppressing the progression of myopia of a wearer is obtained, and when viewing a near distance through this lens, the near vision region can be used, so that an accommodation lag is less likely to occur, and in this respect as well, the progression of myopia is suppressed. In addition, the myopia progression suppressing regions 2 are disposed in regions having a concentration of astigmatism, and do not obstruct normal vision.

### Second Embodiment

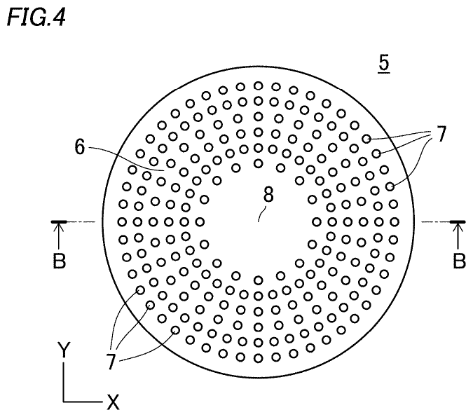

A second embodiment is a variation of the first embodiment. A myopia suppressing lens 5 of the second embodiment has the same properties as the progressive properties illustrated in FIGS. 1A and 1B of the myopia suppressing lens 1 of the first embodiment, and are designed under the same basic design conditions as those of the myopia suppressing lens 1. In the myopia suppressing lens 5 of the second embodiment, a myopia progression suppressing region 6 is formed in a ring shape so as to surround a clear vision region 8 disposed at the lens center as illustrated in FIG. 4. Spots 7 of the myopia suppressing lens 5 are individually shaped into the same convex lenses as the spots 3 of the first embodiment, but are arranged in a different pattern. The myopia progression suppressing region 6 consists of a group of 6 toric curved rows formed by concentrically arranging a large number of spots 7. The large number of spots 7 are successively arranged at intervals of 2 to 3 mm in the row direction, and the rows are arranged in an orderly manner so that a distance between row centerlines is 4 mm.

With the myopia suppressing lens 5 of the second embodiment, it is assumed to obtain an effect of suppressing the progression of myopia by suppressing hyperopic blur in the retina periphery, and an effect of suppressing the progression of myopia by preventing an accommodation lag is further added.

In addition, in comparison with a progressive power lens to be frequently used as a means to simply prevent an accommodation lag and suppress the progression of myopia, by surrounding a lens use portion by spots, the effect can be prevented from being reduced by half due to a failure of alignment between a wearer's eye position and the lens, such as sliding down of the eyeglasses.

It is also possible that a vertically long elliptic non-spot portion is provided so that the far vision portion and the near vision portion are formed as non-spot portions.

### Third Embodiment

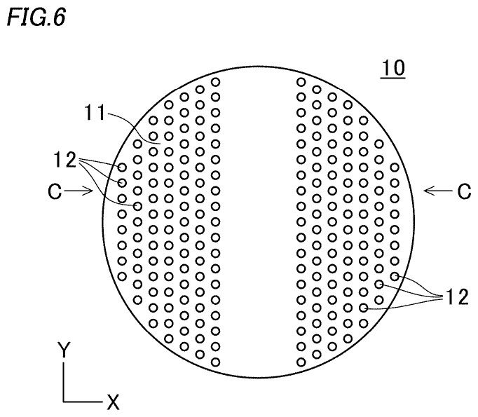

A third embodiment is also a variation of the first embodiment. A myopia suppressing lens 10 of the third embodiment has the same properties as the progressive properties illustrated in FIGS. 1A and 1B of the myopia suppressing lens 1 of the first embodiment, and are designed under the same basic design conditions as those of the myopia suppressing lens 1. As illustrated in FIG. 6, myopia progression suppressing regions 11 of the third embodiment are disposed at both left and right sides avoiding, in particular, a region in which the visual line moves up and down (width of approximately 20 to 30% of a lens diameter length in the left-right direction) at the center in a lens vertical direction. Spots 12 of the myopia suppressing lens 11 are individually shaped into the same convex lenses as the spots 3 of the first embodiment, but are arranged in a different pattern. The myopia progression suppressing regions 11 consist of groups disposed separately at the left and the right and each including 7 linear rows. The large number of spots 12 are arranged at intervals of 3 mm in the row direction, and the rows are successively arranged in an orderly manner so that a distance between row centerlines is 4 mm.

With the myopia suppressing lens 10 of the third embodiment, since the spots 12 are absent in the far vision region and the near vision region, while usability as an eyeglass lens is improved, an effect of suppressing the progression of myopia is extracted by surrounding the visual field by the myopia suppressing regions at the lateral portions. As compared with the first embodiment, spots are disposed at the lateral sides of the far vision portion as well, so that the effect of suppressing the progression of myopia caused by hyperopic blur in the retina periphery is considered to become relatively great.

### Fourth Embodiment

A fourth embodiment is also a variation of the first embodiment. The myopia suppressing lens 10 of the fourth embodiment has the same properties as the progressive properties illustrated in FIGS. 1A and 1B of the myopia suppressing lens 1 of the first embodiment, and are designed under the same basic design conditions as those of the myopia suppressing lens 1.

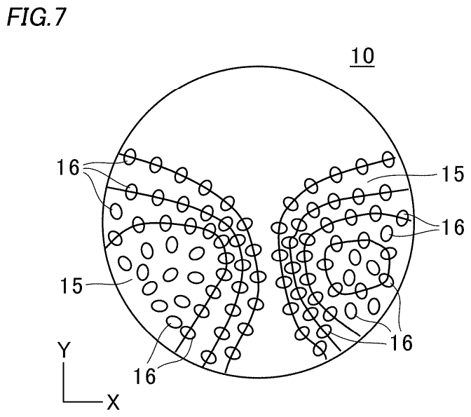

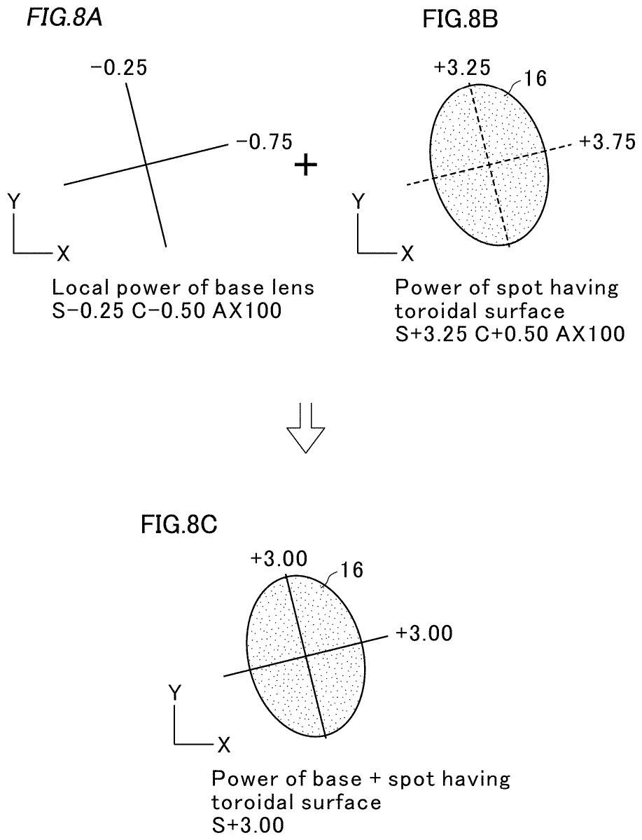

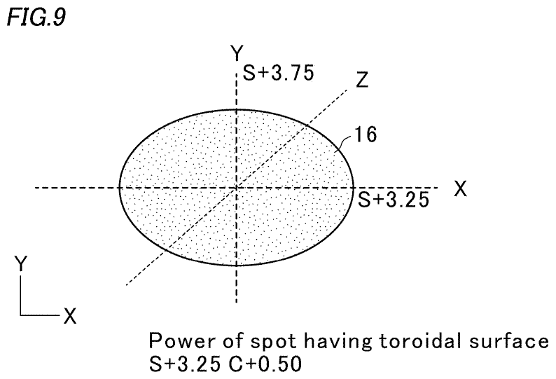

In the fourth embodiment, spots 16 of myopia progression suppressing regions 15 disposed on a lens front surface have different shapes and different arrangement angles. In the fourth embodiment, description is given by focusing on the shapes and arrangement angles of the spots 16. As illustrated in FIGS. 7 and 8A-8C, the large number of spots 16 of the fourth embodiment are formed of toroidal surfaces the lengths and curvatures of which become maximum and minimum in longitudinal and transverse directions orthogonal to each other. As illustrated in FIG. 9, when C1 represents the curvature in the X direction and C2 represents the curvature in the Y direction, a sag amount Z (form of line passing through the center of the toroidal surface) of the spot 16 is defined as:

Z=(C1×X²+C2×Y²/(1+sqrt(1−C1²×X²+C²×Y²)

Here, it is assumed that, as illustrated in FIG. 8A, the myopia suppressing lens 10 that becomes a base has a local power of S −0.25D C −0.50D and an astigmatic axial direction (AX) 100 based on the X direction. On the other hand, the toroidal surface of the spot 16 is expressed as S+3.25D and C+0.50D in terms of diopter, and when the spot 16 overlaps the myopia suppressing lens 10 in a state where the phase is changed by 100° rotation (AX100) based on the X direction, their C powers cancel each other and disappear. C power is astigmatism, and astigmatism at this position can be canceled out by disposing the spot 16 at a proper angle (phase). The proper angle is an angle that causes a maximum power direction of the local power of the myopia suppressing lens 10 and a maximum power direction of the toroidal surface of the spot 16 to become orthogonal to each other. However, a slight angle deviation is allowed, so that by roughly disposing the spots in such angle directions, astigmatism in the myopia progression suppressing region 15 can be canceled, and the burden on the wearer's eye can be reduced.

As illustrated in FIG. 7, as a result of providing progressive properties to the spots 16, in the peripheral region of the myopia suppressing lens 10 in which astigmatism occurs, the spots 16 are disposed to cancel the astigmatism. The maximum power direction of the toroidal surface of the spot 16 disposed on a contour line of astigmatism is substantially orthogonal to the astigmatism. A phase of the spot 16 not on the contour line is also determined in consideration of astigmatism. A larger number of spots (also in various sizes) than in FIG. 7 can be disposed according to the direction of astigmatism.

Accordingly, when an image of a light ray passing through the spot region is formed before the retina, the focal depth of the light ray is prevented from being extended according to astigmatism of the base lens, and the image can be stably formed before the retina.

### Fifth Embodiment

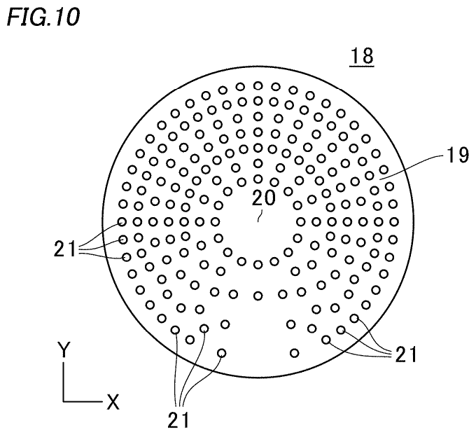

A fifth embodiment is a variation of the second embodiment. As illustrated in FIG. 10, in a myopia suppressing lens 18 of the fifth embodiment, the shape of a myopia progression suppressing region 19 is formed around a clear vision region 20 as with the ring-shaped myopia progression suppressing region 6 of the second embodiment. In the fifth embodiment, unlike the second embodiment, spots 21 constituting the myopia progression suppressing region 19 are disposed to become sparser, that is, lower in density toward the lower side.

With this myopia suppressing lens 18, viewing through, in particular, the near vision region is easier.

### Sixth Embodiment

In the first to fifth embodiments, the curves of the convex lens shapes of the spots 3, 7, 12, and 16 are formed with the same curvature, and accordingly, positive powers added by the spots 3, 7, 12, and 16 are also the same in the myopia progression suppressing regions 6, 11, 15, and 19.

However, in any of these lenses, the lens power (S power) of the near vision region is positive, so that when the positive powers of the spots 3, 7, 12, and 16 are added, a portion overlapping a region to which power is added in the near vision region provides excessive correction. Therefore, it is preferable that positive powers of the spots 3, 7, 12, and 16 disposed in and lower than the near vision region are made smaller (smaller in curvature) than positive powers of the higher spots 3, 7, 12, and 16.

For example, when it is assumed that power of +3D is relatively added to the myopia suppressing region, spots of 2.5D are disposed in a region in which average power of the base lens is 0.5D on average with respect to the far vision power, spots of 2.0D are disposed in a region in which average power of the base lens is 1.0D on average with respect to the far vision power, and spots of 1.5D are disposed in a region in which average power of the base lens is 1.5D on average with respect to the far vision power.

### Seventh Embodiment

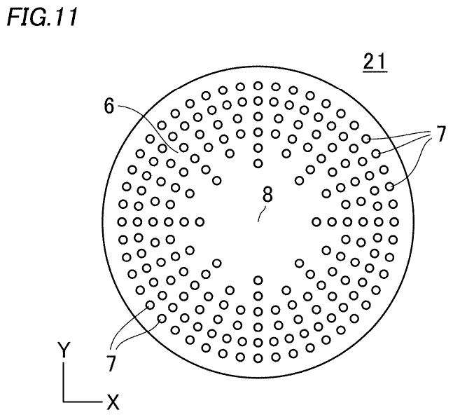

A seventh embodiment is a variation of the second embodiment. In a myopia suppressing lens 21 of the seventh embodiment, as in the second embodiment, the myopia progression suppressing region 6 consisting of the spots 3 is disposed in a ring shape so as to surround the clear vision region 8 disposed at a lens center. However, in the seventh embodiment, as illustrated in FIG. 11, the spots 3 disposed close to the center side of the lens are disposed at a lower distribution density than the spots 3 disposed close to the outer circumference of the lens.

With this myopia suppressing lens 21, the visual line frequently passes through the clear vision region 8, so that normal use as eyeglasses becomes less stressful.

### Eighth Embodiment

An eighth embodiment is a variation of the third embodiment. A distribution state of the spots 12 in two-dimensional directions in the myopia progression suppressing regions 11 in a planar view is the same as in the third embodiment. That is, as in the third embodiment, the myopia progression suppressing regions 11 are disposed at both left and right positions avoiding in particular a region in which the visual line moves up and down (width of approximately 20 to 30% of a lens diameter length in the left-right direction) at the center in a lens vertical direction. However, in the eighth embodiment, refractive power of the spots 12 in a progressive zone region and a near vision region lower than the C line in FIG. 6 is designed to be more positive than refractive power of the spots 12 in the far vision region higher than the C line. In this eighth embodiment, the refractive power is more positive by 1.00D.

In this way, by disposing convex lenses having more positive power at portions where astigmatism and distortion of the progressive power lens concentrate and the visual line rarely passes through, an effect of suppressing the progression of myopia can be efficiently exerted without comparatively losing the visual field.

### Ninth Embodiment

A ninth embodiment is a variation of the eighth embodiment.

In the eighth embodiment, the spots 3 disposed around the far vision region and the spots 3 disposed around the near vision region (lower than C line) are made different in refractive power from each other, however, instead of changing the refractive power from a certain line as in the eighth embodiment, the area ratio of the spots may be gradually changed. The ninth embodiment is an embodiment in which a distribution density (area ratio) of spots in the myopia progression suppressing region is changed.

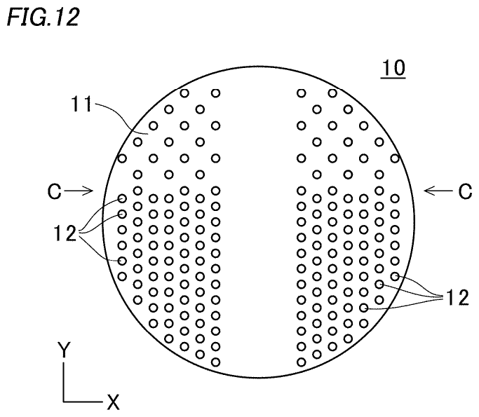

As illustrated in FIG. 12, it is possible that in a region higher than the vicinity of the C line, an area ratio of the spots 3 and a portion other than the spots 3 is set to “sparse” (for example, approximately 0.3 to 1), and in a region lower than the vicinity of the C line, the area ratio of the spots 3 and the portion other than the spots 3 is set to “dense” relative to the region higher than the C line (for example, approximately 0.8 to 1).

### Tenth Embodiment

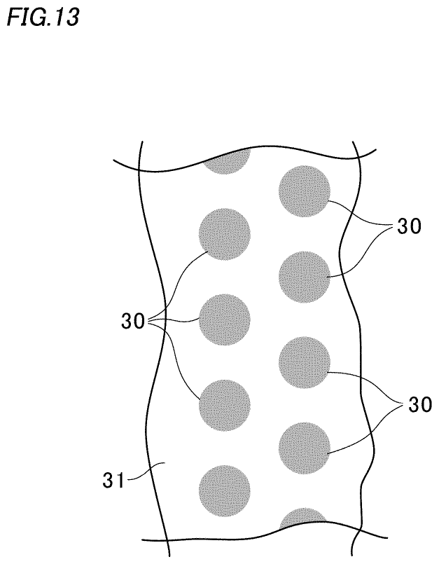

A tenth embodiment is an example in which a large number of spots in a myopia progression suppressing region are not convex lenses but rough surfaces. In the tenth embodiment, as illustrated in FIG. 13, opaque glass-like island-shaped spots 30 are formed on a transparent lens base material in a planar view. In the tenth embodiment, a myopia suppressing lens in which the spots 30 are disposed at the same positions as, for example, distributed positions of the spots 3, 7, 12, and 16 in planar views in FIGS. 2, 4, 6, 7, 10, 11, and 12 can be formed. A myopia suppressing lens 31 having a myopia progression suppressing region including a large number of spots 30 successively disposed at intervals in two-dimensional directions can bring about the same effect as that of the myopia suppressing lenses of the first to ninth embodiments described above.

The above embodiments are merely described as detailed embodiments for illustrating the principle and concept of the present invention. That is, the present disclosure is not limited to the embodiments described above. The present disclosure can also be embodied by, for example, the following modifications.

Shapes and distribution states of the spots 3, 7, 12, and 16 in the respective embodiments described above are just examples, and the present invention may be carried out with other shapes and distribution states.

Astigmatism may be reduced by applying the spots 12 having toroidal surfaces of the fourth embodiment to other embodiments.

The configuration that realizes better vision in the near vision region by arranging spots to become sparse at the lower side as in the fifth embodiment may be applied to other embodiments.

In the embodiments described above, the myopia progression suppressing regions 6, 11, 15, and 19 consist of spots 3, 7, 12, and 16 having the same shape, however, the shapes of the spots do not necessarily have to be the same.

In the sixth embodiment, the positive powers of the spots 3, 7, 12, and 16 disposed in and lower than the near vision region are set to be smaller than positive powers of the higher spots 3, 7, 12, and 16, however, the positive power in the near vision region may be set to be the same or the positive power may be further gradually decreased in the near vision region.

An island-shaped rough surface region may be formed by shapes other than the spots 3, 7, 12 and 16.

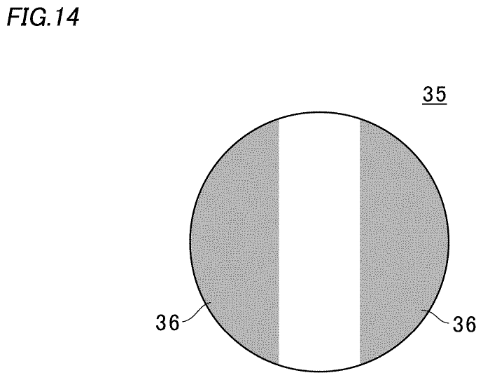

The tenth embodiment is an example in which the convex lenses of the first to ninth embodiments are changed to frosted glass-like rough surfaces, and the rough surface regions are formed into island shapes. However, in the case where the myopia progression suppressing region is formed of rough surfaces, instead of forming the rough surfaces into island shapes as described above, the entire myopia progression suppressing region may be formed of a rough surface. For example, as in FIG. 14, when myopia progression suppressing regions 36 are formed at both left and right positions avoiding a region in which the visual line moves up and down (width of approximately 20 to 30% of a lens diameter length in the left-right direction) in a myopia suppressing lens 35, the entire left and right myopia progression suppressing regions 32 may be formed of frosted glass-like rough surfaces.

The present disclosure is not limited to the configurations described in the above embodiments. Components of the respective embodiments and modifications may be arbitrarily selected and combined. Arbitrary components of the respective embodiments and modifications may be arbitrarily combined with arbitrary components described in the Solution to Problem or components embodying the arbitrary components described in the Solution to Problem. The applicant also has the intention to acquire the rights to such combinations by an amendment, divisional application, or the like of this application.

In addition, the applicant has the intention to acquire the rights to the whole design or a partial design by changing the application to a design application. In the drawings, the entirety of the apparatus concerned is drawn by a solid line, and the drawings include not only the whole design but also a partial design to be claimed for a part of the apparatus. For example, as well as a part of members of the apparatus as a partial design, the drawings also include a part of the apparatus as a partial design independently of the members. A part of the apparatus may be a part of members of the apparatus, or a part of the member.

The present disclosure is further illustrated by the following exemplary aspects.

Aspect 1: An eyeglass lens for suppressing the progression of myopia, comprising: a first region for viewing a comparatively far distance, disposed at an upper side of a lens; and a second region disposed at a lower side than the first region and having more positive refractive power relatively than the first region, wherein a myopia progression suppressing region is disposed to surround a periphery of the first region and the second region.

Aspect 2: The eyeglass lens for suppressing the progression of myopia according to aspect 1, wherein the myopia progression suppressing region consists of a group of a large number of convex lenses having a larger curvature than a front surface of the lens and spaced from each other so as to spread in two-dimensional directions.

Aspect 3: The eyeglass lens for suppressing the progression of myopia according to aspect 2, wherein the group of the convex lenses disposed close to a center side of the lens has a smaller curvature than the group of the convex lenses disposed close to an outer circumference of the lens.

Aspect 4: The eyeglass lens for suppressing the progression of myopia according to aspect 2 or 3, wherein the group of a large number of the convex lenses consists of convex lenses having toroidal surface shapes, and are disposed at an angle that cancels out astigmatism of the lens.

Aspect 5: The eyeglass lens for suppressing the progression of myopia according to aspect 1, wherein the myopia progression suppressing region is a rough surface region in which the lens front surface scatters light, and is configured to surround the periphery of the first region and the second region.

Aspect 6: The eyeglass lens for suppressing the progression of myopia according to aspect 5, wherein the myopia progression suppressing region is configured so as to include a rough surface region that is formed into two or more independent island shapes.

Aspect 7: The eyeglass lens for suppressing the progression of myopia according to any one of aspects 1 to 6, wherein the myopia progression suppressing region is a region that surrounds the first region and the second region from the circumference so as to assume a ring-shaped donut form.

Aspect 8: The eyeglass lens for suppressing the progression of myopia according to any one of aspects 1 to 6, wherein the myopia progression suppressing region is disposed at left and right positions across the first region and the second region.

Aspect 9: The eyeglass lens for suppressing the progression of myopia according to any one of aspects 2 to 4, 7, or 8, wherein a distribution density of the group of a large number of the convex lenses distributed in the myopia progression suppressing region is set to become lower at the lower side than at the upper side.

Aspect 10: The eyeglass lens for suppressing the progression of myopia according to any one of aspects 5 to 8, wherein a distribution density of the large number of spots distributed in the rough surface regions is set to become lower at the lower side than at the upper side.

Aspect 11: The eyeglass lens for suppressing the progression of myopia according to any one of aspects 2 to 4, 7, or 8, wherein a distribution density of the group of a large number of the convex lenses disposed close to the center side of the lens is set to be lower than a distribution density at a position close to the outer circumference of the lens.

Aspect 12: The eyeglass lens for suppressing the progression of myopia according to any one of aspects 5 to 8, wherein a distribution density of the rough surface regions disposed close to the center side of the lens is set to be lower than a distribution density at a position close to the outer circumference of the lens.

Aspect 13: The eyeglass lens for suppressing the progression of myopia according to any one of aspects 2 to 4, wherein the convex lenses disposed in the left-right direction of the second region produce smaller positive power than the convex lenses not disposed in the left-right direction of the second region.

Aspect 14: The eyeglass lens for suppressing the progression of myopia according to any one of aspects 2 to 13, wherein a progressive zone region in which refractive power progressively changes is provided between the first region and the second region, and an addition gradient is set so that addition power is gradually added from the first region to the second region.

Aspect 15: The eyeglass lens for suppressing the progression of myopia according to aspect 14, wherein the myopia progression suppressing region is disposed at left and right positions across the progressive zone region and the second region.

Aspect 16: The eyeglass lens for suppressing the progression of myopia according to aspect 14 or 15, wherein the myopia progression suppressing region is formed on a surface on a side different from either the front surface or the back surface of the lens on which the first region, the second region, and the progressive zone region are provided.

Aspect 17: The eyeglass lens for suppressing the progression of myopia according to aspect 15 or 16, wherein with respect to a surface ratio obtained by dividing a total area occupied by the myopia progression suppressing region by a total area occupied by a portion other than the myopia progression suppressing region, the area ratio in the vicinity of the first region is smaller than the area ratio in the vicinity of the second region.

Aspect 18: The eyeglass lens for suppressing the progression of myopia according to any one of aspects 14 to 17, wherein the myopia progression suppressing region consists of the group of the convex lenses, and refractive power of the convex lens disposed in the vicinity of the progressive zone region and the second region is set to be more positive than refractive power of the convex lens in the myopia progression suppressing region disposed in the vicinity of the first region.

What is claimed is:

1. An eyeglass lens for suppressing the progression of myopia, comprising:
a first region for viewing a comparatively far distance, disposed at an upper side of a lens; and
a second region disposed at a lower side than the first region and having more positive refractive power relatively than the first region,
wherein a myopia progression suppressing region is disposed to surround a periphery of the first region and the second region.

2. The eyeglass lens according to claim 1, wherein the myopia progression suppressing region consists of a group of a large number of convex lenses having a larger curvature than a front surface of the lens and spaced from each other so as to spread in two-dimensional directions.

3. The eyeglass lens according to claim 2, wherein the group of the convex lenses disposed close to a center side of the lens has a smaller curvature than the group of the convex lenses disposed close to an outer circumference of the lens.

4. The eyeglass lens according to claim 3, wherein the group of a large number of the convex lenses consists of convex lenses having toroidal surface shapes, and are disposed at an angle that cancels out astigmatism of the lens.

5. The eyeglass lens according to claim 4, wherein a distribution density of the group of a large number of the convex lenses distributed in the myopia progression suppressing region is set to become lower at the lower side than at the upper side.

6. The eyeglass lens according to claim 1, wherein the myopia progression suppressing region consists of a group of a large number of convex lenses having a larger curvature than a front surface of the lens and spaced from each other so as to spread in two-dimensional directions; wherein the group of the convex lenses disposed close to a center side of the lens has a smaller curvature than the group of the convex lenses disposed close to an outer circumference of the lens; and wherein a distribution density of the group of a large number of the convex lenses disposed close to the center side of the lens is set to be lower than a distribution density at a position close to the outer circumference of the lens.

7. The eyeglass lens according to claim 1, wherein the myopia progression suppressing region is a rough surface region in which the lens front surface scatters light, and is configured to surround the periphery of the first region and the second region.

8. The eyeglass lens according to claim 7, wherein the myopia progression suppressing region is configured so as to include a rough surface region that is formed into two or more independent island shapes.

9. The eyeglass lens according claim 8, wherein a distribution density of the large number of spots distributed in the rough surface regions is set to become lower at the lower side than at the upper side.

10. The eyeglass lens according to claim 1, wherein the myopia progression suppressing region is a rough surface region in which the lens front surface scatters light, and is configured to surround the periphery of the first region and the second region; and wherein a distribution density of the rough surface regions disposed close to the center side of the lens is set to be lower than a distribution density at a position close to the outer circumference of the lens.

11. The eyeglass lens according to claim 1, wherein the myopia progression suppressing region consists of a group of a large number of convex lenses having a larger curvature than a front surface of the lens and spaced from each other so as to spread in two-dimensional directions; and wherein the convex lenses disposed in the left-right direction of the second region produce smaller positive power than the convex lenses not disposed in the left-right direction of the second region.

12. The eyeglass lens according to claim 1, wherein the myopia progression suppressing region consists of a group of a large number of convex lenses having a larger curvature than a front surface of the lens and spaced from each other so as to spread in two-dimensional directions; and wherein a progressive zone region in which refractive power progressively changes is provided between the first region and the second region, and an addition gradient is set so that addition power is gradually added from the first region to the second region.

13. The eyeglass lens according to claim 12, wherein the myopia progression suppressing region is disposed at left and right positions across the progressive zone region and the second region.

14. The eyeglass lens according to claim 13, wherein with respect to a surface ratio obtained by dividing a total area occupied by the myopia progression suppressing region by a total area occupied by a portion other than the myopia progression suppressing region, the area ratio in the vicinity of the first region is smaller than the area ratio in the vicinity of the second region.

15. The eyeglass lens according to claim 14, wherein the myopia progression suppressing region consists of the group of the convex lenses, and refractive power of the convex lens disposed in the vicinity of the progressive zone region and the second region is set to be more positive than refractive power of the convex lens in the myopia progression suppressing region disposed in the vicinity of the first region.

16. The eyeglass lens according to claim 1, wherein the myopia progression suppressing region consists of a group of a large number of convex lenses having a larger curvature than a front surface of the lens and spaced from each other so as to spread in two-dimensional directions; wherein a progressive zone region in which refractive power progressively changes is provided between the first region and the second region, and an addition gradient is set so that addition power is gradually added from the first region to the second region; and wherein the myopia progression suppressing region is formed on a surface on a side different from either the front surface or the back surface of the lens on which the first region, the second region, and the progressive zone region are provided.

17. The eyeglass lens according to claim 16, wherein with respect to a surface ratio obtained by dividing a total area occupied by the myopia progression suppressing region by a total area occupied by a portion other than the myopia progression suppressing region, the area ratio in the vicinity of the first region is smaller than the area ratio in the vicinity of the second region.

18. The eyeglass lens according to claim 17, wherein the myopia progression suppressing region consists of the group of the convex lenses, and refractive power of the convex lens disposed in the vicinity of the progressive zone region and the second region is set to be more positive than refractive power of the convex lens in the myopia progression suppressing region disposed in the vicinity of the first region.

19. The eyeglass lens according to claim 1, wherein the myopia progression suppressing region is a region that surrounds the first region and the second region from the circumference so as to assume a ring-shaped donut form.

20. The eyeglass lens according to claim 19 wherein a distribution density of the group of a large number of the convex lenses distributed in the myopia progression suppressing region is set to become lower at the lower side than at the upper side.

21. The eyeglass lens according to claim 1, wherein the myopia progression suppressing region is disposed at left and right positions across the first region and the second region.

22. The eyeglass lens according claim 21, wherein a distribution density of the large number of spots distributed in the rough surface regions is set to become lower at the lower side than at the upper side.
